(19) United States
(12) Patent Application Publication
(10) Pub. No.: US 2004/0059775 A1
(43) Pub. Date: Mar. 25, 2004

(54) Method, system and computer program product for remotely building and delivering customized multimedia presentations

(75) Inventor: Peter Robert Jacobs, Rochester, MN (US)

Correspondence Address: Grant A. Johnson, IBM Corporation - Dept. 917, 3605 Highway 52 North, Rochester, MN, 55901, US

(73) Assignee: International Business Machines Corporation, Armonk, NY

(21) Appl. No.: 10/246,986

(22) Filed: Sep. 19, 2002

(51) Int. Cl. G06F 15/16

(52) U.S. Cl. 709/203; 709/206; 709/219

(57) ABSTRACT

A method, system and computer program product is provided for remotely building and delivering customized multimedia presentations. An online form is presented a to a user. The online form identifies a plurality of media clips. At least one user selected media clip is received for a customized media presentation. A customized viewing uniform resource locator (URL) is embedded in an email. The customized viewing URL contains control information identifying each received user selected media clip. The email is sent to a target end user and the control information in the customized viewing URL is used for presenting the customized multimedia presentation including each user selected media clip to the target end user.

### FIELD OF THE INVENTION

The present invention relates generally to the data processing field, and more particularly, relates to a method, system and computer program product for remotely building and delivering customized multimedia presentations.

### DESCRIPTION OF THE RELATED ART

The World Wide Web (WWW) or the Internet enables a wealth of information to be retrieved and delivered to a requesting end user. Many different browser applications are available for use in viewing Web pages.

In the Internet environment, it is desirable to enable the creation and delivery of customized multimedia presentations to a target audience of users. Customized multimedia presentations are useful for various applications, such as, for education or training applications, business communication, and the like.

A need exists for a mechanism for both building and delivering multimedia presentations that can be effectively presented or conveyed to a target audience of end users. It is also desirable to build customized multimedia presentations for different target audiences.

### SUMMARY OF THE INVENTION

A principal object of the present invention is to provide a method, system and computer program product for remotely building and delivering customized multimedia presentations. Other important objects of the present invention are to provide such method, system and computer program product for remotely building and delivering customized multimedia presentations substantially without negative effect and that overcome many of the disadvantages of prior art arrangements.

In brief, a method, system and computer program product is provided for remotely building and delivering customized multimedia presentations. An online form is presented a user. The online form identifies a plurality of media clips. At least one user selected media clip is received for a customized media presentation. A customized viewing uniform resource locator (URL) is embedded in an email. The customized viewing URL contains control information identifying each received user selected media clip. The email is sent to a target end user and the control information in the customized viewing URL is used for presenting the customized multimedia presentation including each user selected media clip to the target end user.

In accordance with features of the invention, the customized multimedia presentation can include one or a combination of streaming audio, video, and slides. The customized multimedia presentation can include a selected sequence of multiple user selected media clips.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a computer system for implementing remotely building and delivering customized multimedia presentations in accordance with the preferred embodiment;

FIG. 2 is a flow chart illustrating exemplary steps for implementing remotely building and delivering customized multimedia presentations in accordance with the preferred embodiment;

FIG. 3 is an exemplary display screen of a client computer in the computer system of FIG. 1 illustrating an exemplary user interface for providing user selections in accordance with the preferred embodiment; and

FIG. 4 is a block diagram illustrating a computer program product in accordance with the preferred embodiment.

### DETAILED DESCRIPTION OF THE PREFERRED EMBODIMENTS

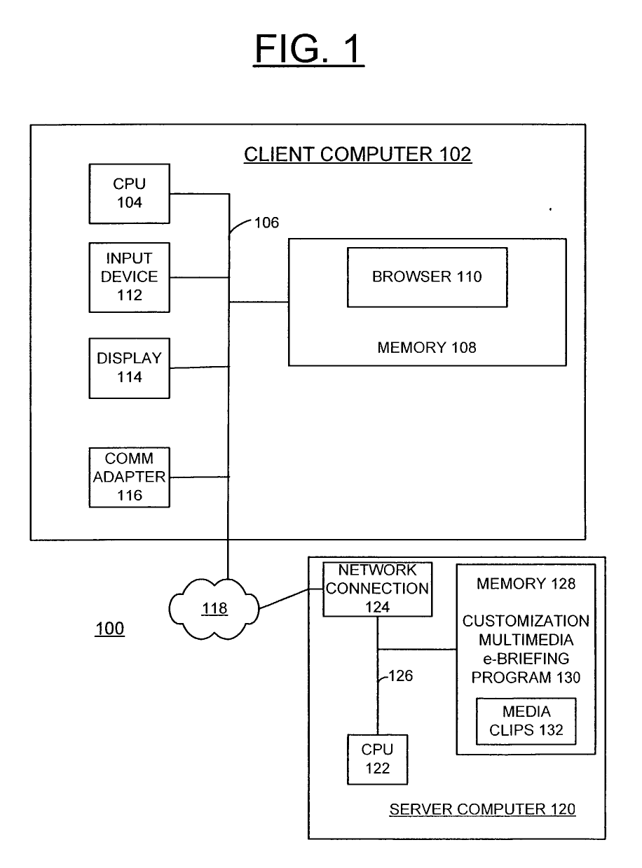

Having reference now to the drawings, in FIG. 1, there is shown a computer or data processing system generally designated by the reference character 100 for implementing the customized multimedia presentation method of the preferred embodiment. As shown in FIG. 1, computer system 100 includes a plurality of client computers 102 (one shown). Client computer 102 includes a central processor unit (CPU) 104 connected via a bus 106 to a memory 108 containing a browser 110. CPU 102 is connected to an input device 112, a display device 114. CPU 102 is connected to a communications adapter 120 providing a communications function. Client computer 102 is connected via a network 118, such as the Internet, to a server computer 120.

Server computer 120 includes a central processor unit (CPU) 122 connected to a network connection 124 via a bus 126. Network connection 124 connects server computer 120 to the network 118. CPU 122 is connected to a memory 128 containing a customization multimedia e-briefing program 130 of the preferred embodiment. A plurality of available media clips 132 is stored for implementing customized multimedia presentations of the preferred embodiment. Although one server computer 120 is shown in FIG. 1, it should be understood that a multiplicity of server computers could be provided, for example, for storing the available media clips 132.

In accordance with features of the invention, a user, such as a member of the executive briefing center or a business partner, is enabled to construct a customized multimedia presentation that contains streaming audio, video, and slides. The complete presentation is presented to the target audience via the respective browser 110 of each target end user.

Customization multimedia e-briefing program 130 includes a selection web-based application that guides the user through the process of building a customized presentation from an existing array of presentation segments or media clips 132. The segments or media clips 132 included in the customized presentation can include audio/video, slides, table of contents, or any combination thereof. Customization multimedia e-briefing program 130 includes a function to generate email or other profile type record that identifies the content of the customized presentation in machine-readable format for accessing the presentation delivery server 120. Customization multimedia e-briefing program 130 includes a presentation Web based application that reads the customized presentation profile information and delivers the specified presentation content in sequence via real time streaming protocol (RTSP), PNM, or HTTP, existing technologies.

Browser 110 can be implemented with any of various currently available standard browsers. Examples of currently available browsers include Netscape Navigator and Microsoft Internet Explorer. Client computers 102 may be implemented using any suitable client computer, such as an IBM personal computer running the OS/2® operating system. Server computer 120 may be implemented using any suitable server such as the AS/400® computer system, running the OS/400® operating system, both products of International Business Machines Corporation, located in Armonk, N.Y.

Client computers 102 and server computer 120 could be other types of computer systems, whether they be microcomputers such as an Apple Macintosh or mainframe computers such as an IBM System/390, and still fall within the spirit and scope of this invention. In addition, client computers 102 and server computer 120 could be microcomputers such as described above but connected to a larger computer system. Client computers 102 could also be a computer such as an Internet appliance or thin client that does not have a fixed disk drive. It will be readily appreciated that the principles of the invention may apply to other computer applications, such as other mainframes, minicomputers, network servers, supercomputers, personal computers, or workstations, as well as other electronics applications. It should be understood that the invention is not limited to the particular hardware designs, software designs, communications protocols, performance parameters, or application-specific functions disclosed herein.

In accordance with features of the invention, a creation form and a viewing page are accessible through the Internet or WWW. The method of the invention enables a user or author to create a unique multimedia presentation for each target end user, such as a customer. An email having an embedded uniform resource locator (URL) containing unique control information for the customized multimedia presentation is sent to the target end user. The multimedia presentation is not emailed, only unique control information, making the email file size extremely small, avoiding any graphics limitations of the email client. The viewing page to generate a dynamic presentation uses the unique control information. The customized presentation is viewed through a conventional Internet browser.

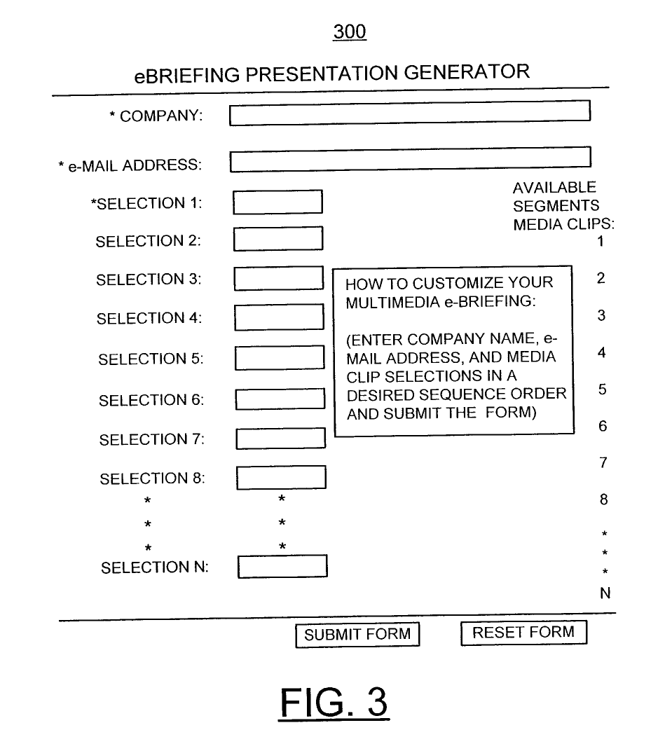

In operation, the person initiating the presentation uses a topic listing in an online form, such as illustrated and described with respect to FIG. 3; that is available through the browser 110 of client computer 102. In this selection process clips are chosen and assembled in an order that is unique for their target audience. After the selection process has completed a unique URL is embedded in an email and sent to the target end user. When this email is received the target end user clicks the link contained in the email and is taken to a web page that appears to contain their custom briefing presentation. In actuality, custom briefing presentation is dynamically generated by the web page using control information that is passed in the email to the target user. Each email can be forwarded to any number of customers or clients.

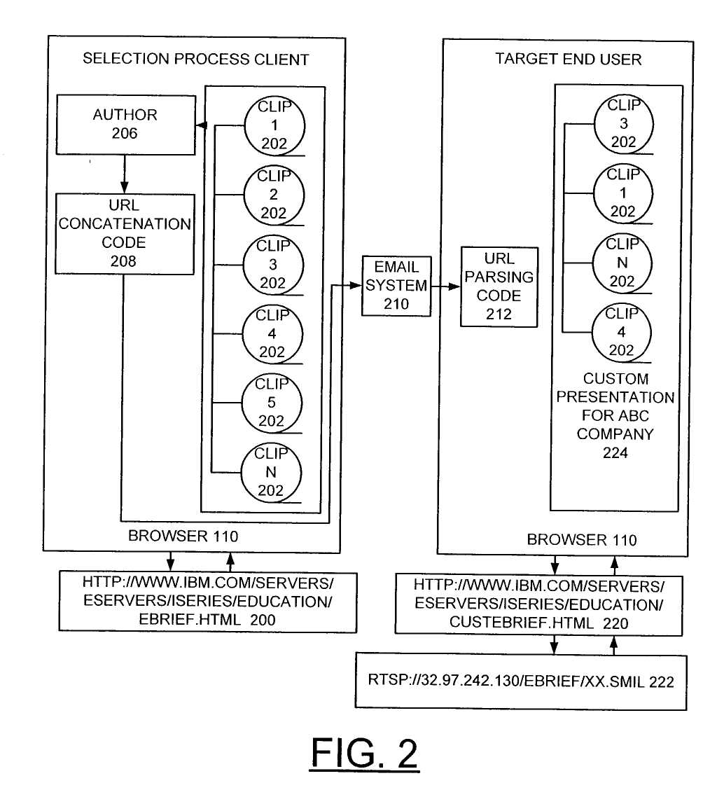

Referring now to FIG. 2, there are shown exemplary sequential steps in accordance with the method, apparatus and computer program product of the preferred embodiment. A uniform resource locator (URL) of the selection web based application indicated at a block 200 loads an on-line form, such as an HTML form served by the web server 120 and displayed to the author on the client browser 110. A list of presentation segments or media clips as indicated in blocks are presented in the on-line form for selection by an author indicated in block 206.

Referring also to FIG. 3, there is shown an exemplary user interface e-briefing presentation generator for receiving user selections generally designated by the reference character 300 for implementing the customized multimedia presentation method of the preferred embodiment. E-briefing presentation generator includes fields for receiving user selections of a target end user, an email address for the target end user, and a plurality of presentation segments or media clips. The e-briefing presentation generator 300 displays instructions for the author to customize a multimedia e-briefing and a list describing available presentation segments or media clips. The author enters the name and email address for the target end user and selects one or more of the presentation segments or media clips in a desired order for the customized multimedia presentation. Once the author has identified the media clips in the desired sequence for viewing, the form is submitted for processing.

Referring again to FIG. 2, a unique or customized URL concatenation code containing control information for the author selected sequence of presentation segments or media clips is embed in an email as indicated in a block 208. The email is sent to the target end user via an email system as indicated in a block 210. A confirmation is displayed to the author after the email is sent to the target user.

At the target browser 110, email content is parsed by a URL parsing code as indicated in a block 212 for accessing the presentation delivery server 120. A presentation Web based application as indicated in a block 220 utilizes the customized presentation profile information of the URL and delivers the specified presentation content in sequence via real time streaming protocol as indicated in a block 222 and provides the custom presentation as indicated in a block 224 viewed through the browser 110 of the target end user. The customized multimedia presentation method of the preferred embodiment does not require any server side Common Gateway Interface (CGI) code or CGI programs such as typically invoked on a server to process an HTML form submitted from a client to the server.

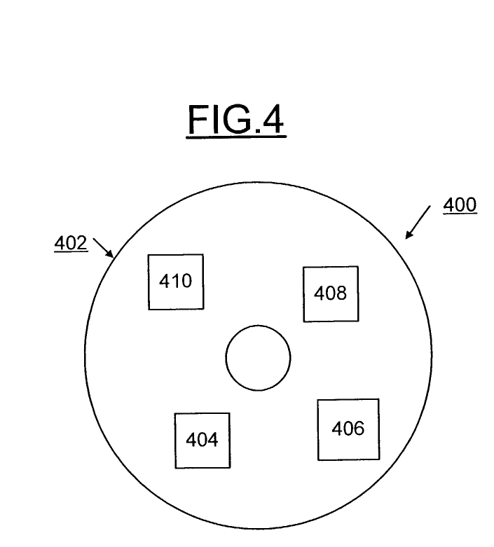

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for custom e-briefing creation process of the preferred embodiment in the computer system 100 of FIG. 1.

A sequence of program instructions or a logical assembly of one or more interrelated modules defined by the recorded program means 404, 406, 408, 410, direct the computer system 100 to perform the custom e-briefing creation method of the invention.

While the present invention has been described with reference to the details of the embodiments of the invention shown in the drawing, these details are not intended to limit the scope of the invention as claimed in the appended claims.

What is claimed is:

1. A method for remotely building and delivering a customized multimedia presentation comprising the steps of:
presenting an online form to a user; said online form identifying a plurality of media clips;
receiving at least one user selected media clip for a customized media presentation;
responsive to receiving said at least one user selected media clip, embedding a customized viewing uniform resource locator (URL) in an email; said customized viewing URL containing control information identifying each said received user selected media clip;
sending said email having said customized viewing URL to a target end user; and
utilizing said control information in said customized viewing URL for presenting the customized multimedia presentation including said user selected media clips to the target end user.

2. A method for remotely building and delivering a customized multimedia presentation as recited in claim 1 wherein the step of presenting said online form includes the steps of utilizing a browser of a client computer to access a selection web based application.

3. A method for remotely building and delivering a customized multimedia presentation as recited in claim 2 further includes the steps of displaying said online form via said browser; and said online form containing fields for receiving user selected target email address and said

4. A method for remotely building and delivering a customized multimedia presentation as recited in claim 1 wherein the step of receiving at least one user selected media clip for the customized media presentation includes the steps of receiving multiple user selected media clips for the customized media presentation.

5. A method for remotely building and delivering a customized multimedia presentation as recited in claim 4 further includes the steps of receiving a user selected sequence of said multiple user selected media clips for the customized media presentation.

6. A method for remotely building and delivering a customized multimedia presentation as recited in claim 5 includes the step of embedding said customized viewing uniform resource locator (URL) in an email; said customized viewing URL containing control information identifying said user selected sequence of said multiple user selected media clips.

7. A method for remotely building and delivering a customized multimedia presentation as recited in claim 1 includes the step of providing a confirmation message to the user responsive to sending said email to said target end user.

8. A method for remotely building and delivering a customized multimedia presentation as recited in claim 1 wherein the step of utilizing said control information in said customized viewing URL for presenting the customized multimedia presentation including each said user selected media clip to the target end user includes the step of dynamically generating the customized multimedia presentation containing a combination of one or more of streaming audio, video, and slides.

9. A method for remotely building and delivering a customized multimedia presentation as recited in claim 1 wherein the step of utilizing said control information in said customized viewing URL for presenting the customized multimedia presentation including each said user selected media clip to the target end user includes the steps of delivering each said user selected media clips to the target end user in sequence.

10. A computer program product comprising:
a computer usable medium; and
a computer readable code embodied on the computer usable medium, said computer readable code configured to cause a computer to generate an email having an embed customized viewing URL containing control information identifying received user selected media clips in a user selected order.

11. A computer program product as recited in claim 10 further includes computer readable code to cause a computer to utilize said embed customized viewing URL for presenting the customized multimedia presentation including said user selected media clips in said user selected order to a target end user.

12. A system for remotely building and delivering a customized multimedia presentation for a web browser comprising:
a server computer for presenting an online form to a client browser; said online form identifying a plurality of media clips;
a creation web based application for receiving client selections of at least one media clip for the customized multimedia presentation and generating an email containing a customized viewing uniform resource locator (URL) including control information identifying each said client selected media clip; and
a viewing web based application for utilizing said customized viewing URL for presenting the customized multimedia presentation including each said client selected media clip to a target end user.

13. A system for remotely building and delivering a customized multimedia presentation for a web browser as recited in claim 12 wherein said creation web based application for receiving client selections of a sequence for multiple media clips and generating said email containing said customized viewing uniform resource locator (URL) including control information identifying said sequence for multiple media clips.

14. A system for remotely building and delivering a customized multimedia presentation for a web browser as recited in claim 12 wherein said multimedia presentation includes a combination of one or more of streaming audio, video, and slides presented to the target end user.
